(19) United States
(12) Patent Application Publication
(10) Pub. No.: US 2008/0088094 A1
(43) Pub. Date: Apr. 17, 2008

(54) Micro-Channel Seals

(75) Inventors: Richard Borowski, Canton, OH (US); Richard A. Knepper, Noth Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, Canton, OH (US)

(21) Appl. No.: 11/791,319

(22) PCT Filed: Dec. 6, 2005
(86) PCT No.: PCT/US05/44026

§ 371 Date: May 21, 2007

Related U.S. Application Data
(60) Provisional application No. 60/633,768, filed on Dec. 7, 2004.

(51) Int. Cl. F16J 15/32

(52) U.S. Cl. 277/559

(57) ABSTRACT

A seal assembly (100) between an elastomeric seal component (110) and a surface (102) of a rotating component (104) which incorporates at least one micro-channel (106) having discrete branching elements (108, 108A) or micro-recesses (114). The micro-channels (106) are formed on either the surface of the rotating component (104) or the elastomeric seal component (110), and are configured to provide a uniform and unidirectional wear surface. The micro-channels (106) permit a controlled amount of lubricant to flow to the elastomeric seal region (R) area while creating a barrier to prevent lubricant axial migration beyond the elastomeric seal region (R). The controlled lubrication reduces seal wear, extends the seal life, and results in a reduced chance of leakage if the elastomeric seal component (110) is misaligned relative to the rotating component surface (102).

### CROSS REFERENCE TO RELATED APPLICATIONS

This application is the US National Phase under 35 U.S.C. §371 of International Application No. PCT/US2005/044026 and which is, related to and claims priority from U.S. Provisional Patent Application No. 60/633,768 filed Dec. 7, 2004 entitled MICRO-CHANNEL SEALS, herein incorporated by reference.

### TECHNICAL FIELD

This invention relates generally to sealing arrangements between rotating and non-rotating components, and in particular, towards a method and apparatus for utilizing micro-channel surface features on at least one of the components to provide improved lubricant sealing between the rotating and non-rotating components.

### BACKGROUND ART

During the manufacture of a rotating component such as a shaft or bearing member, a surface of the rotating component is commonly machined to a desired diameter via a grinding process. Typically, the grinding process introduces grinding marks or leads along the axial length of the rotating component. If the component is rotating and translating axially during the grinding process, the grinding marks or leads will form a helical pattern on the surface of the rotating component.

An elastomeric component, such as a labyrinth seal, or a seal lip seated against a surface of the rotating component, will not maintain a good seal against a flow of lubricant or the incursion of contaminates if helical or skewed grinding leads are present on the rotating component surface. The helical or skewed grinding leads generate a directional pumping action on the lubricant film between the elastomeric seal lip and the rotating component surface, resulting in lubricant leakage or the introduction of external contaminates into the lubricant reservoir.

Accordingly, when machining the outer diameter of a rotating component in the area in which a circumferential elastomeric seal lip is to be seated, a plunge grinding process is commonly utilized. During the plunge grinding process, the grinding wheel or component is brought into contact with the component surface while the component is held in a fixed longitudinal position and rotated axially, resulting in grinding marks or leads on the component surface in the range of 0.00025 mm (10μ-in.) to 0.0005 mm (20μ-in.) which are generally circumferential, i.e. perpendicular to the component centerline axis.

An ideal “plunge ground” finish avoids the development of any directional pumping action, and allows for a thin film of lubricant to form between the elastomeric seal element lip and the rotating component surface, reducing frictional seal wear, heat generation, and operating torque.

However, some skewed or misaligned secondary grinding marks or leads will generally be present on the surface of the rotating component after a plunge grind process, resulting in undesired directional pumping action for lubricant under the elastomeric seal element lip. These secondary grinding marks or leads may be the result of particulate material trapped between the grinding surface and the rotating component surface during the grinding procedure, or the result of mechanical vibrations occurring during the grinding procedure.

For elastomeric components such as seal lips which contact surfaces between rotating components, the preferred contact width (axial distance) that the elastomeric seal lip covers along the rotating component surface is 0.25 mm (0.01 in.)-1.0 mm (0.04 in.). Any increase in this contact width will prevent a sufficient lubricant film from being maintained, as areas under the elastomeric seal element lip will be insufficiently lubricated and will run dry. Additionally, as the surface wears to a smoother finish, it is less able to maintain a desired lubricant film beneath the elastomeric seal lip.

Previous attempts to provide a better performing wear surface on a rotating component, i.e. one which lowers torque, has reduced heat generation, and which maintains a uniform and stable lubricant film, have employed discrete microstructures on the surface of the rotating component in place of the plunge ground finish, such as shown in prior art FIG. 1. However, discrete microstructures are independent of each other, and provide pathways interconnected axially along the component surface through which lubricants and contaminants can travel past the elastomeric seal lip contact region. Lubricants and contaminants moving through the pathways between discrete microstructures can pass under the elastomeric seal element lip, either resulting in a lubricant leak, or introducing contaminants into the lubricant reservoir.

Accordingly, it would be advantageous to provide an elastomeric seal assembly of consistent manufacture, having a long operational life which exerts a reduced amount of torque on the rotating component surface, thereby reducing power consumption and heat generation in a mechanical system, as well as reducing maintenance costs associated with the replacement of worn elastomeric seal components.

### BRIEF DESCRIPTION OF THE DRAWINGS

FIG. 1 is a representative perspective view of prior art discrete micro-structures on a material surface;

FIG. 2 is an illustration of the surface of a rotating component including a set of circumferential parallel micro-channels of an alternate embodiment of the present invention, each incorporating a plurality of unidirectional angular flutes;

FIG. 3 is a partial sectional view of a rotating component, illustrating a set of rectangular cross-sectioned micro-channels of the present invention;

FIG. 4 is a sectional view of a portion of a rotating component, illustrating a set of semi-circular cross-sectioned micro-channels of the present invention;

FIG. 5 is a partial sectional view of a rotating component, illustrating a set of triangular cross-sectioned micro-channels of the present invention;

FIG. 6 is a sectional illustration of exemplary spatial relationships between a contacting elastomeric seal element and a set of micro-channels of the present invention disposed on an outer surface of a rotating component;

FIG. 7 shows a surface of a rotating component including a set of circumferential parallel micro-channels of an alternate embodiment of the present invention, each incorporating a plurality alternating angular flutes;

FIG. 8 is an illustration similar to FIG. 7, in which the rotating component surface includes opposed sets of circumferential parallel micro-channels having a plurality of alternating angular flutes;

FIG. 9 is an illustration similar to FIG. 6, in which the rotating component surface includes opposed sets of circumferential parallel micro-channels having a plurality of angular flutes;

FIG. 10 is an illustration of an alternate embodiment of the present invention incorporating a set of parallel micro-channels in the surface of the elastomeric seal lip contacting a rotating component surface;

FIG. 11 shows an alternate embodiment of the present invention in which a surface of a rotating component includes a pair of circumferential branching micro-channels having opposed perpendicularly-aligned flutes or branches; and

FIG. 12 is an illustration of a surface of a rotating configured according to an alternate embodiment of the present invention with a set of parallel circumferential micro-channels linking discrete micro-recesses.

### BEST MODES FOR CARRYING OUT THE INVENTION

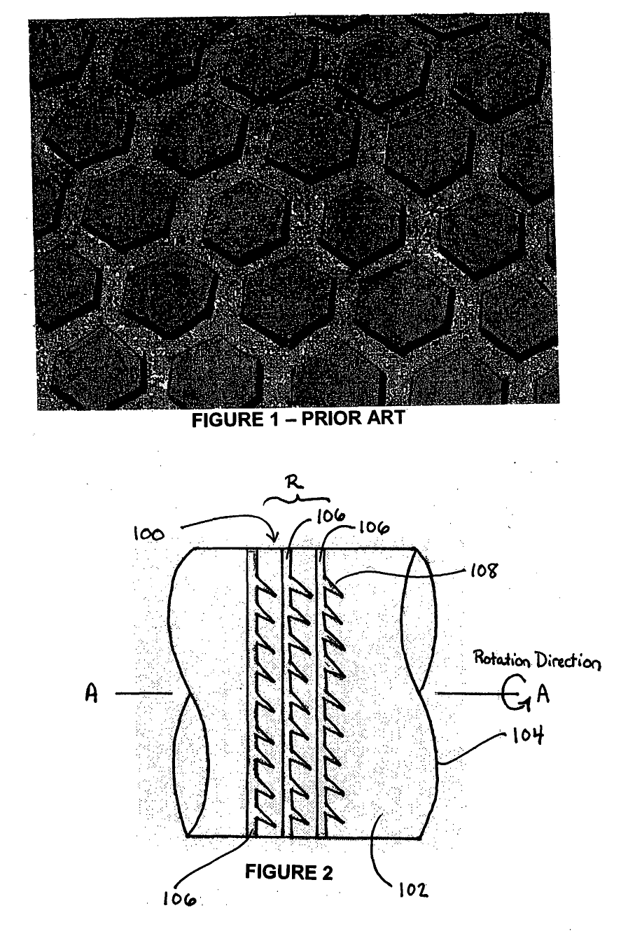

Turning to FIG. 2, a preferred embodiment of the micro-channel seal assembly 100 of the present invention is illustrated on the outer surface 102 of a rotating component 104. The micro-channel seal assembly 100 consists of a set of parallel micro-channels 106 circumscribing the outer surface 102 of the rotating component 104. The micro-channels are orientated perpendicular to the longitudinal axis A-A of the rotating component 104, and are disposed to overlap a circumferential contact region R about which an elastomeric seal element lip surrounds the rotating component 104. Each micro-channel 106 is discrete and contiguous about the circumference of the rotating component, such that no uninterrupted axial pathway exists between opposite sides of the micro-channel seal assembly on the rotating component surface.

A set of parallel and uniformly-spaced angular flutes 108 or branches extend from each micro-channel 106. The angular flutes 108 are tapered to a point as they extend from the micro-channel 106, and may have any of a variety of cross-sections, such as semicircular or triangular.

The angular flutes 108 are preferably aligned at an acute angle relative to the micro-channel 106, such that through the rotation of the rotating component 104, a pumping action may be imparted by the angular flutes 108 on either lubricants or contaminates entering the circumferential contact region. The angular orientation of the flutes 108, and their alignment relative to the longitudinal axis A-A of the rotating component 104 determines a resulting longitudinal direction of any pumping action. For example, as shown in FIG. 2, the combination of the rotation of the rotating component about the longitudinal axis A-A as indicated by the arrow, and the orientation of the angular flutes 108, may result in a pumping action towards each micro-channel 106 from which each angular flute 108 extends.

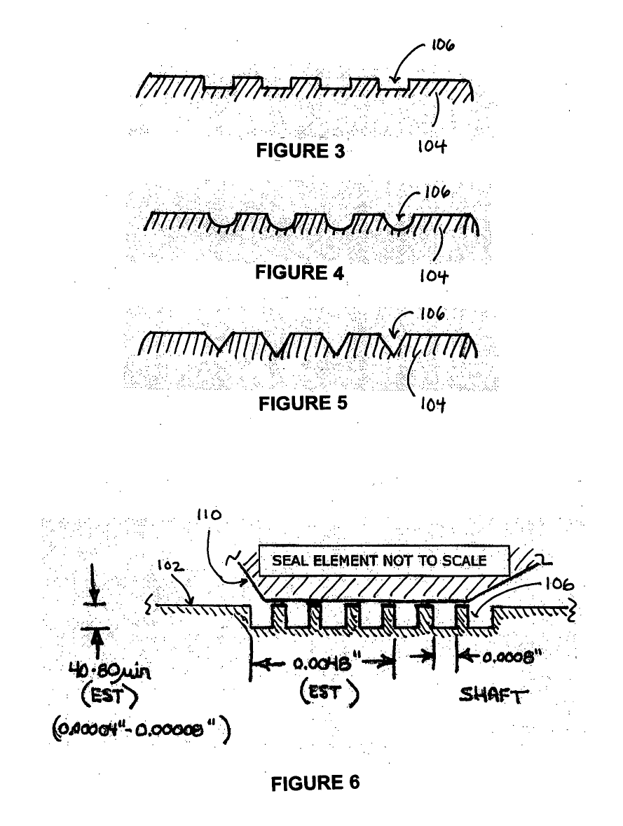

As shown in FIGS. 3-5, each micro-channel 106 has a cross sectional shape which may be rectangular, semi-circular, or triangular. Those of ordinary skill in the art will recognize that the cross-sectional shape of discrete micro-channels 106 in a set of micro-channels 100 may be varied, depending upon the particular seal application, and that a variety of cross-sectional shapes may be utilized for micro-channels 106 in addition to those illustrated in FIGS. 3-5. For example, micro-channels 106 having cross-sectional shapes particularly suited for capturing contaminates may be disposed adjacent to the environmentally-exposed (dry) edge of an elastomeric seal element, while micro-channels 106 having cross-sectional shapes particularly suited for holding a lubricant may be disposed adjacent to the lubricant reservoir (wet) edge of the elastomeric seal element.

Using a combination of micro-channel cross-sectional shapes in a micro-channel seal assembly 100 may provide increased resistance to contaminate penetration while maintaining a desired lubricant film between an elastomeric seal lip and the rotating component 104.

In the preferred embodiment of the micro-channel seal assembly 100 of the present invention, each of the micro-channels 106 and angled flutes 108 has a cross-sectional depth of between 0.001 mm (40μ-inches)-0.002 mm (80μ-inches), and a cross-sectional width of approximately 0.02 mm (0.0008 in.), as shown in FIG. 6. In this preferred configuration a set of micro-channels 100 is disposed within a elastomeric seal lip contact region R having a width of 0.51 mm (0.020 in.), which is within the preferred contact region width of 0.25 mm (0.010 in.)-1.0 mm (0.040 in.) for elastomeric seals 110.

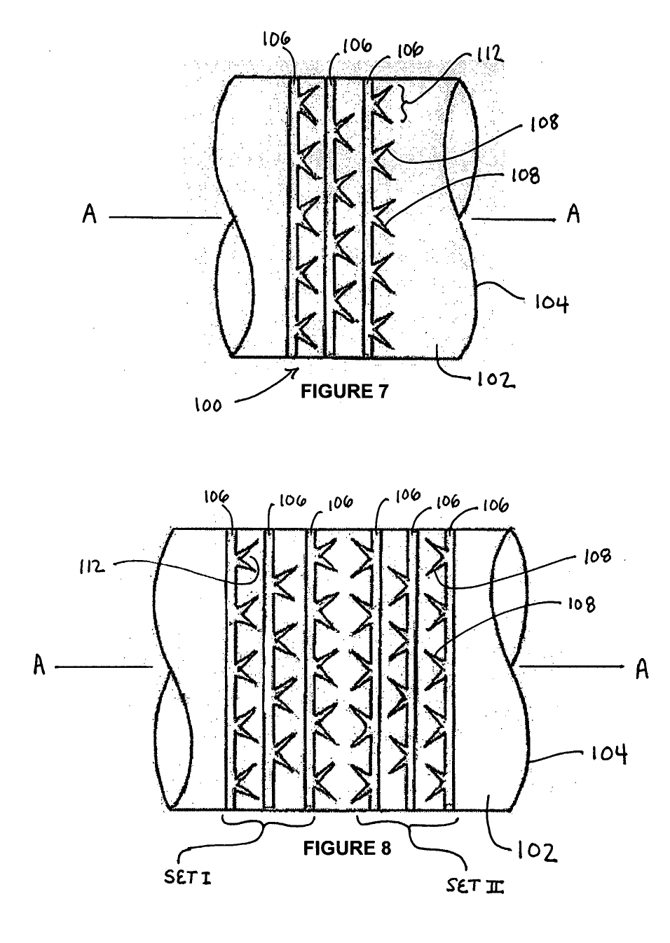

For some seal applications it is desirable to exert a unidirectional pumping action or force on a lubricant film disposed between a surrounding elastomeric seal lip 110 or labyrinth seal (not shown) and the rotating component surface 102. As shown in FIG. 2, a set of micro-channels 106 each incorporating angular flutes 108 aligned in a common direction, may generate a unidirectional pumping action or force on a lubricant film during rotation of the rotating component 104. Correspondingly, for applications in which a bi-directional pumping action or force is desired, a set of micro-channels 106 each incorporating sets 112 of paired angular flutes 108 aligned along opposing acute angles relative to the micro-channels 106, may be optionally provided on the rotating component surface 102, as shown in FIG. 7.

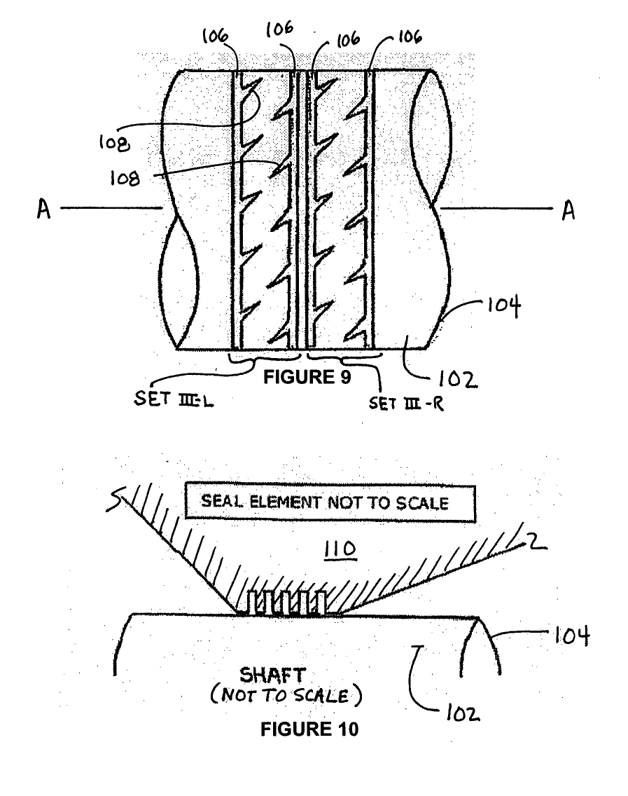

Those of ordinary skill in the art will recognize that by incorporating micro-channels 106 having specifically-aligned angular flutes 108 in a micro-channel seal assembly 100, combinations of unidirectional and bi-directional pumping actions or forces may be exerted on a lubricant film disposed in the contact region R between an elastomeric seal lip and a rotating component surface 102, stabilizing the lubricant film or directing lubricant and contaminate flow patterns. FIGS. 8 and 9 provide illustrative examples of such alternate embodiments of the micro-channel seal assemblies 100 of the present invention in which various sets (identified as Set I, Set II, Set III-L and Set III-R) of micro-channels 106, having angular flutes 108 and pairs of flutes 112, are arranged in combinations. Those of ordinary skill in the art will recognize that individual micro-channels 106 with angular flutes 108, and sets of micro-channels 106 with angular flutes, may be disposed on a surface 102 of a rotating component 104 in any of a wide variety of configurations and combinations, and that the illustrations shown herein are not intended to be limiting or restricting.

While each of the above embodiments and variations of a micro-channel seal assembly 100 of the present invention has been described in connection with the micro-channels 106 disposed on the outer surface 102 of the rotating component 104, those of ordinary skill in the art will recognize that the micro-channel seal assembly 100 of the present invention may be achieved by disposing the micro-channels 106 with angular flutes 108 on any type of seal surface, such as the inner diametrical surface of the annular elastomeric seal element 110, as shown in FIG. 10. Alternatively, micro-channels may be disposed on surfaces of both the elastomeric seal element 110 and the rotating component 104, and may be selected to have angular flutes 108 with complimentary configurations, enhancing the functionality of the seal assembly 100.

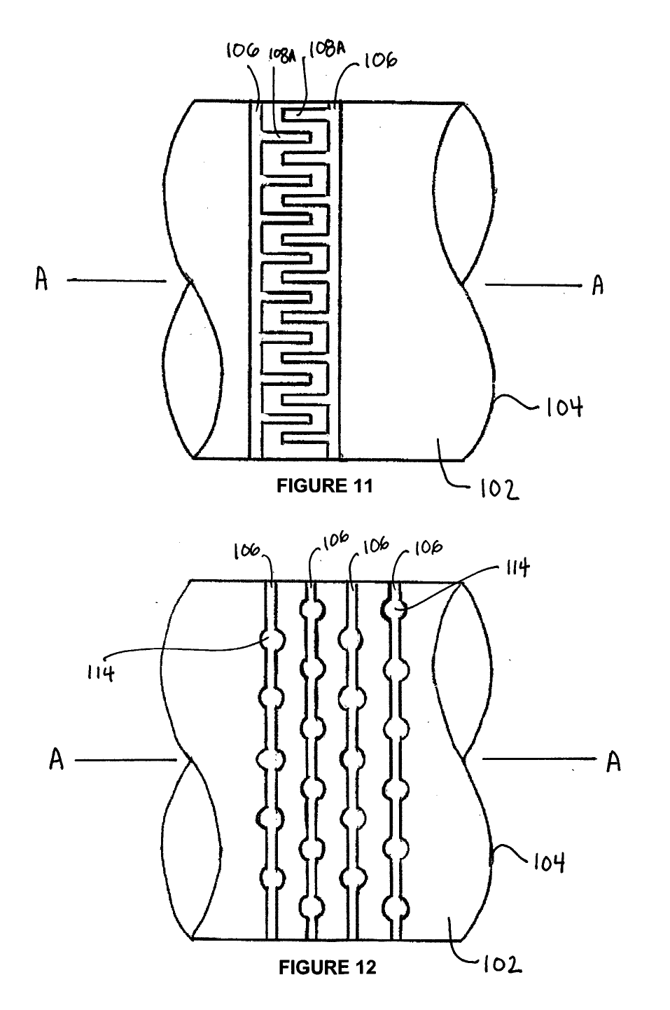

Turning to FIGS. 11 and 12, those of ordinary skill in the art will recognize that a variety of alternate configurations of branching elements may be utilized with the micro-channels 106 of the present invention in place of angular flutes 108. For example, as is shown in FIG. 11, the angular flutes 108 may be replaced with perpendicular flutes or branches 108A which are aligned perpendicular to the micro-channels 106. Such perpendicular flutes or branches 108A may serve to collect lubricant fluid or contaminates from the seal region R, without imparting a pumping action. Similarly, as is shown in FIG. 12, a plurality of discrete micro-recesses 114 may be linked by a micro-channel 106, and may serve to provide reservoirs for holding lubricants or retaining contaminates which enter the seal contact region R. The discrete micro-recesses 114 may be hemispherical, as shown in FIG. 12, or may be any of a variety of configurations, such as conical, pyramidal, rectangular, or pyramidal. Furthermore, the discrete-micro-recesses 114 do not need to be centrally aligned with the associated micro-channels 106, but rather, could be including asymmetrically disposed about the associated micro-channels 106.

Those of ordinary skill in the art will further recognize that a variety of methods may be employed to form the micro-channels 106 and flutes 108 of the present invention on either the rotating component surface 102 or the elastomeric seal surfaces (either directly or by formation in the elastomeric seal mold elements). For example, a LIGA process involving X-ray lithography, electroplating, and plastic molding may be utilized to form the micro-channels 106 or flutes 108 on the surface 102 of the rotating component 104, or alternatively, on a mold surface from which an elastomeric seal element 110 is formed. Alternatively formation methods include laser ablation deposition, electro-discharge machining (EDM), dry etching, ultrasonic machining, ultra-high precision mechanical machining, and electro-less (Ni) plating.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An improved seal assembly between a rotating component having a longitudinal axis and an annular elastomeric seal element disposed about a contact region of the rotating component, the improvement comprising:
at least one discrete micro-channel disposed within the contact region between the rotating component and the annular elastomeric seal element, said discrete micro-channel continuous about a circumference of the seal assembly and including a plurality of uniformly-spaced discrete elements.

2. The improved seal assembly of claim 1 wherein said plurality of uniformly-spaced discrete elements are selected from a set of elements including angular flutes, perpendicular flutes, pairs of angular flutes, and discrete micro-recesses.

3. The improved seal assembly of claim 1 wherein said discrete micro-channel is aligned perpendicular to the longitudinal axis of the rotating component.

4. The improved seal assembly of claim 1 wherein said at least one discrete micro-channel is disposed on an outer surface of the rotating component.

5. The improved seal assembly of claim 1 wherein said at least one discrete micro-channel is disposed on a surface of the elastomeric seal element.

6. The improved seal assembly of claim 1 wherein at least one discrete micro-channel is disposed on an outer surface of the rotating component; and
wherein at least one discrete micro-channel is disposed on a surface of the elastomeric seal elements.

7. An improved seal assembly between a rotating component having a longitudinal axis and an annular elastomeric seal element disposed about a contact region of the rotating component, the improvement comprising:
a plurality of parallel micro-channels disposed within the contact region between the rotating component and the annular elastomeric seal element, each of said plurality of micro-channels discrete from each other and continuous about a circumference of the seal assembly; and
at least one of said micro-channels including a set of discrete spaced-apart recessed elements configured to interact with a material disposed within the contact region.

8. The improved seal assembly of claim 7 wherein said discrete spaced-apart recessed elements are aligned angular flutes configured to impart a first pumping action on materials disposed within the contact region.

9. The improved seal assembly of claim 8 wherein said aligned angular flutes are configured to impart a unidirectional pumping action on said materials.

10. The improved seal assembly of claim 7 wherein said discrete spaced-apart recessed elements are pairs of opposing angular flutes, said pairs of angular flutes configured to impart a bidirectional pumping action on said materials.

11. The improved seal assembly of claim 8 further including at least a second micro-channel including a set of aligned angular flutes configured to impart a second pumping action on materials disposed within said contact region, said second pumping action having a different direction from said first pumping action.

12. The improved seal assembly of claim 7 wherein said material is a lubricant film.

13. The improved seal assembly of claim 7 wherein said material is a seal contaminate.

14. The improved seal assembly of claim 7 wherein said discrete spaced-apart elements are aligned angular flutes configured to provide a flow pathway for materials disposed within the contact region.

15. The improved seal assembly of claim 7 wherein said discrete spaced-apart elements are micro-recesses configured to retain materials disposed within the contact region.

16. The improved seal assembly of claim 7 wherein said plurality of parallel micro-channels are configured to preclude uninterrupted axial Pathways across said contact region.

17. The improved seal assembly of claim 7 wherein said discrete spaced-apart recessed elements are tapered flutes.

18. The improved seal assembly of claim 1 further including at least one additional discrete micro-channel disposed within the contact region between the rotating component and the annular elastomeric seal element, said at least one additional discrete micro-channel continuous about a circumference of the seal assembly and including a plurality of uniformly-spaced discrete elements; and
wherein each of said discrete micro-channels are axially isolated from each other.
